(19) United States
(12) Patent Application Publication
(10) Pub. No.: US 2011/0055758 A1
(43) Pub. Date: Mar. 3, 2011

(54) SMART NAVIGATOR FOR PRODUCTIVITY SOFTWARE

(75) Inventors: Christoph Lukasiak, Hamburg (DE); Kai-Sven Ahrens, Hamburg (DE)

(73) Assignee: SUN MICROSYSTEMS, INC., Santa Clara, CA (US)

(21) Appl. No.: 12/552,511

(22) Filed: Sep. 2, 2009

(51) Int. Cl. G06F 3/048

(52) U.S. Cl. 715/812; 715/841; 715/854; 715/779

(57) ABSTRACT

A productivity software application in which a user chooses actions, from at least one of a menu bar, a tool bar, or a task pane, runs on a computer. While running the productivity software application, the computer monitors actions chosen by the user. Data is generated that represents a navigation menu. The navigation menu includes a limited set of choices based on previous actions chosen by the user in the productivity software application. The computer outputs the data representing the navigation menu for visual display, and receives input indicative of a user choice from the limited set of choices in the navigation menu.

### BACKGROUND OF THE INVENTION

1. Field of the Invention

The invention relates to productivity software. The invention further relates to an office software suite for word processing, spreadsheets, presentations, graphics, and databases.

2. Background Art

The use of productivity software has become widespread. One of the most common types of productivity software is the office software suite. An office software suite may provide software for word processing, spreadsheets, presentations, graphics, and databases. For example, OpenOffice.org is an office application suite available for a number of different computer operating systems.

The user interface for productivity software, and in particular for an office application suite, typically includes a menu bar, one or more tool bars, task panes, etc. A menu bar is a region where computer menus are housed. Its purpose is to house window- or application-specific menus which provide access to such functions as opening files, interacting with an application, or help. Menu bars are typically present in graphical user interfaces (GUIs) with windows. A toolbar is a GUI widget on which onscreen buttons, icons, menus or other input or output elements are placed. A task pane is a dockable dialog window that gives users a convenient way to use commands, gather information, and modify their documents.

### SUMMARY OF THE INVENTION

In one embodiment of the invention, a computer-readable storage medium having instructions stored thereon is provided. The instructions direct a computer to, while running a productivity software application wherein a user chooses actions, monitor actions chosen by the user in the productivity software application. The computer is further directed to generate data representing a navigation menu. The navigation menu includes a limited set of choices based on previous actions chosen by the user in the productivity software application. Data representing the navigation menu is output for visual display. The computer is further directed to receive input indicative of a user choice from the limited set of choices in the navigation menu.

At the more detailed level, the invention comprehends a variety of features. One or more of the various additional features may be included in an embodiment of the invention, as appropriate for the implementation.

In one embodiment, while running the productivity software application, the user chooses actions from at least one of: a menu bar, a tool bar, and a task pane. The computer monitors actions chosen by the user from at least one of: a menu bar, a tool bar, and a task pane. The limited set of choices in the navigation menu is based on previous actions chosen by the user from at least one of: a menu bar, a tool bar, and a task pane.

It is appreciated that the navigation menu may include, among the limited set of choices, at least one navigation choice. Upon receiving input indicative of a user choice being a navigation choice, the computer generates data representing a next navigation menu. The next navigation menu includes a second limited set of choices based on the navigation choice, and further based on previous actions chosen by the user in the productivity software application. Thereafter, the data representing the next navigation menu is output for visual display.

In some implementations, the navigation menu includes a preselected user choice. The user may navigate among the limited choices, or simply select the preselected choice. The navigation menu may include an undo/back choice.

Prior to the previous actions chosen by the user in the productivity software application being sufficient to determine the limited set of choices for the navigation menu, the navigation menu may include a default limited set of choices.

It is appreciated that embodiments of the invention are not limited to productivity software applications. Depending on the implementation, the navigation menus and associated functions may be provided for other software applications. As well, embodiments of the invention are not limited to desktop or laptop computers. In one implementation, when the embodiment is for a productivity software application, the productivity software application comprises an office software suite.

It is also possible for the computer to generate and display more than one navigation menu. As well, the computer may generate different navigation menus for different users. That is, actions chosen in the software application may be tracked on a per user basis.

In some embodiments of the invention, the navigation menu includes, among the limited set of choices, at least one change mode choice. Upon receiving input indicative of a user choice being the change mode choice, the computer generates data representing a full navigation menu. The full navigation menu includes the limited set of choices and further includes a plurality of support choices. The additional support choices may include a help choice, a next choice, and a self choice. The help choice causes the computer to display help related information. The next choice causes the computer to display a next navigation menu including a second limited set of choices based on previous actions chosen by the user in the productivity software application. The self choice causes the computer to display a next navigation menu including a second limited set of choices that are custom selected by the user (for example, a custom menu created by the user, or a custom menu downloaded by the user from the web). Some embodiments may omit the change mode selection, and always show the navigation menu in the full, more detailed mode.

There are many advantages associated with embodiments of the invention. Embodiments of the invention may provide simple navigation inside software, with the navigator being self-learning. This navigation is in addition to classical navigation methods. In another advantage, the navigator may be useful as an accessibility feature.

### BRIEF DESCRIPTION OF THE DRAWINGS

FIG. 1 illustrates an office application including a navigation menu in an embodiment of the invention;

FIG. 2 illustrates the office application including the navigation menu in the full, more detailed mode;

FIGS. 3-7 are block diagrams illustrating methods of the invention; and

FIG. 8 is a computer system in an embodiment of the invention.

### DETAILED DESCRIPTION OF THE PREFERRED EMBODIMENTS

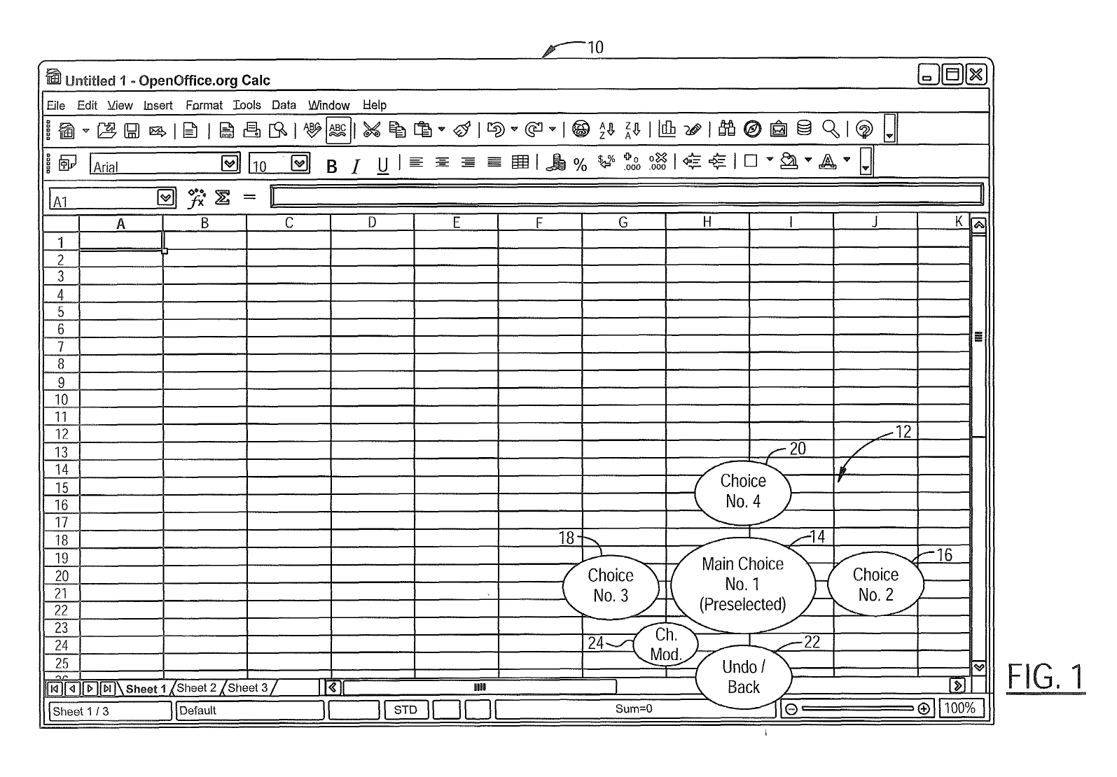

FIG. 1 illustrates an office application 10 in an embodiment of the invention. The office application 10 is a productivity software application running on a computer. In office application 10, a user chooses actions from a menu bar and various tool bars. The computer monitors actions chosen by the user in the office application 10. The computer also generates data representing a navigation menu, and outputs the data representing the navigation menu for visual display at 12. The navigation menu 12 includes a limited set of choices 14, 16, 18, and 20 based on previous actions chosen by the user in the office application 10.

The navigation menu 12 is in addition to traditional menus, tool bars, etc. for the office application 10. The navigation menu 12 allows fast navigation inside office application 10 with minimal knowledge and efforts.

In this illustrated embodiment, the navigation menu 12 is completely operable by the arrow keys on the keyboard (up, down, left, right) which are for most people intuitively usable. Selection may be performed with the return key. In the alternative, a navigation menu may also be operated with a mouse, joystick, limited keyboard, on-screen keyboard devices or alternative accessibility devices, etc. The user of the office application 10 may, while using office application 10, use the various menu and tool bars, and the navigation menu at the same time, switching between different ways to choose actions at the user's convenience. In addition to the choices 14, 16, 18, and 20, undo/back choice 22 is also provided to give the user an easy way to undo a chosen action.

In the illustrated embodiment of FIG. 1, the navigation menu 12 shows only the four most probable choices 14, 16, 18, and 20 for the user, with the first choice 14 being preselected. Preselection is indicated in any suitable way to show emphasis, such as highlighting the current choice. A highlighted choice may be chosen by pushing the return key.

As mentioned above, the computer monitors actions chosen by the user in office application 10. This is performed using suitable user tracking software, which will track every move of the user, if the user tracking has not been switched off. The information gathered during monitoring is utilized to provide a smart navigator for productivity software that is capable of learning and is not fixed in the way that an existing menu bar is fixed. The information gathered during monitoring is stored in a best-choices database. The information is used by the system to learn the best choices for presentation in the navigation menu 12. As many users do the same things over and over again or search for things they have done before, the limitation of choices in the navigation menu 12 is advantageous, particularly when the presented choices are learned by monitoring user actions over time. It is appreciated that the computer may generate different navigation menus for different users. That is, actions may be tracked on a per user basis.

In another aspect of some embodiments of the invention, it may be possible to let the user create his or her own best choices. That is, the limited set of choices in the navigation menu 12 may be at least partially selected by the user to create a customized menu. It could also be possible for a user to download and install customized navigation menus from the web. Further, software may be provided to assist the user in setting up the navigation menu for use, giving the user the option to customize the menu or accept the default navigation menu, and the option to turn monitoring and learning on or off.

It is appreciated that embodiments of the invention may provide navigation as opposed to a single static set of possible selections as found in a traditional tool bar. That is, in FIG. 1, selection of one of the choices 14, 16, 18, 20 may cause the computer to display a next navigation menu based on the selected choice and based on past actions chosen by the user. That is, the user may navigate through possible actions, with only a limited set being presented at a given time. Embodiments of the invention advantageously provide only a limited number of smart choices, so as to consume only a limited area of the desktop (screen) space. As well, multiple navigators could be present on the screen at the same time.

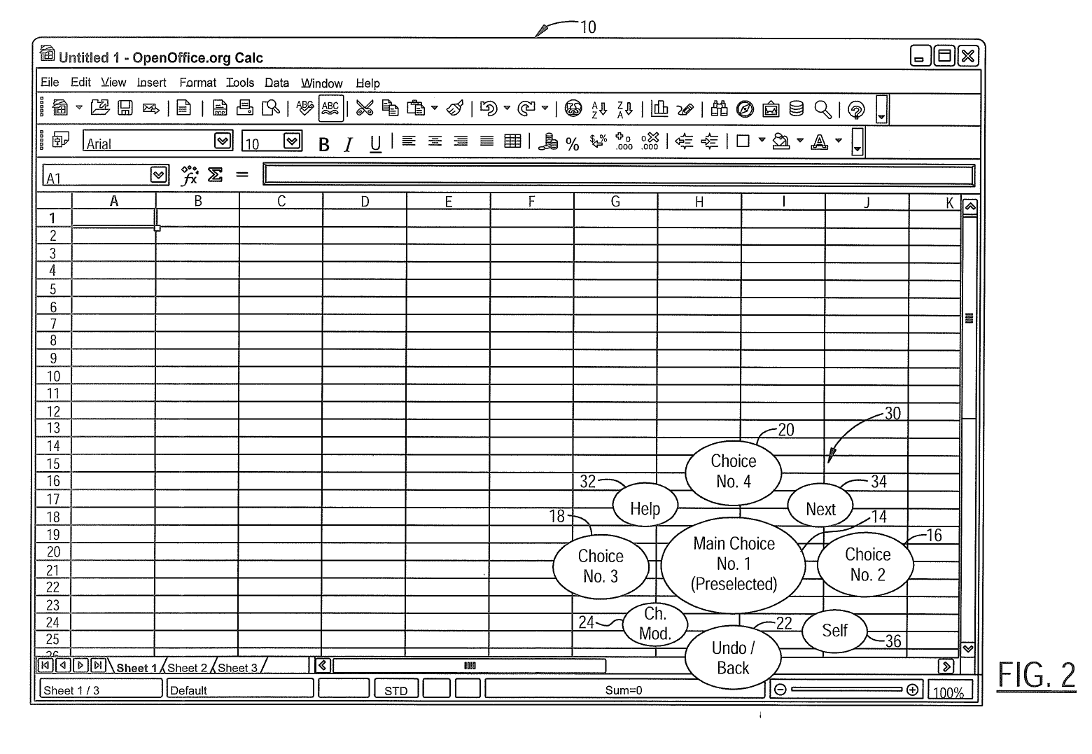

With continuing reference to FIG. 1, a change mode choice 24 is also provided in the illustrated embodiment. By selecting change mode choice 24, an expanded functionality is made available. Turning to FIG. 2, the expanded functionality in the illustrated embodiment includes additional navigation support functions.

Upon receiving input indicative of a user choice being the change mode choice 24, the computer generates data representing a full navigation menu 30 in FIG. 2. The full navigation menu 30 includes the limited set of choices and further includes a plurality of support choices. The additional support choices may include a help choice 32, a next choice 34, and a self choice 36. The help choice 32 causes the computer to display help related information. The next choice 34 causes the computer to display a next navigation menu including a second limited set of choices based on previous actions chosen by the user in the office application 10. Put another way, navigation menu 30 displays choices 14, 16, 18, and 20. Selecting next 34 will result in navigation menu 30 displaying new choices 14, 16, 18, and 20. The system could initially present the four most likely choices, with next 34 causing the fifth through eight likely choices to then be displayed in navigation menu 30.

The self choice 36 causes the computer to display a next navigation menu including a second limited set of choices that are custom selected by the user as described previously. That is, the system would initially present the four most likely choices, with self 36 causing the four choices learned by the system to be replaced with four choices that are custom selected by the user. Some embodiments may omit the change mode selection 24, and always show the navigation menu in the full, more detailed mode. Additional functionality may also be provided by self button 36, such as the ability to change the appearance of the navigator in size, look and behavior.

It is appreciated that the kind of navigation provided by the navigation menus 12 and 30, and by other embodiments of the invention, could be used for other software and is not limited to office application 10. For example, portable applications such as those on personal digital assistants (PDAs), etc., may benefit from embodiments of the invention as the choices are probably better, the smaller the software (and its function set). As well, embodiments of the invention are well-suited for small keyboards or other inputting methods.

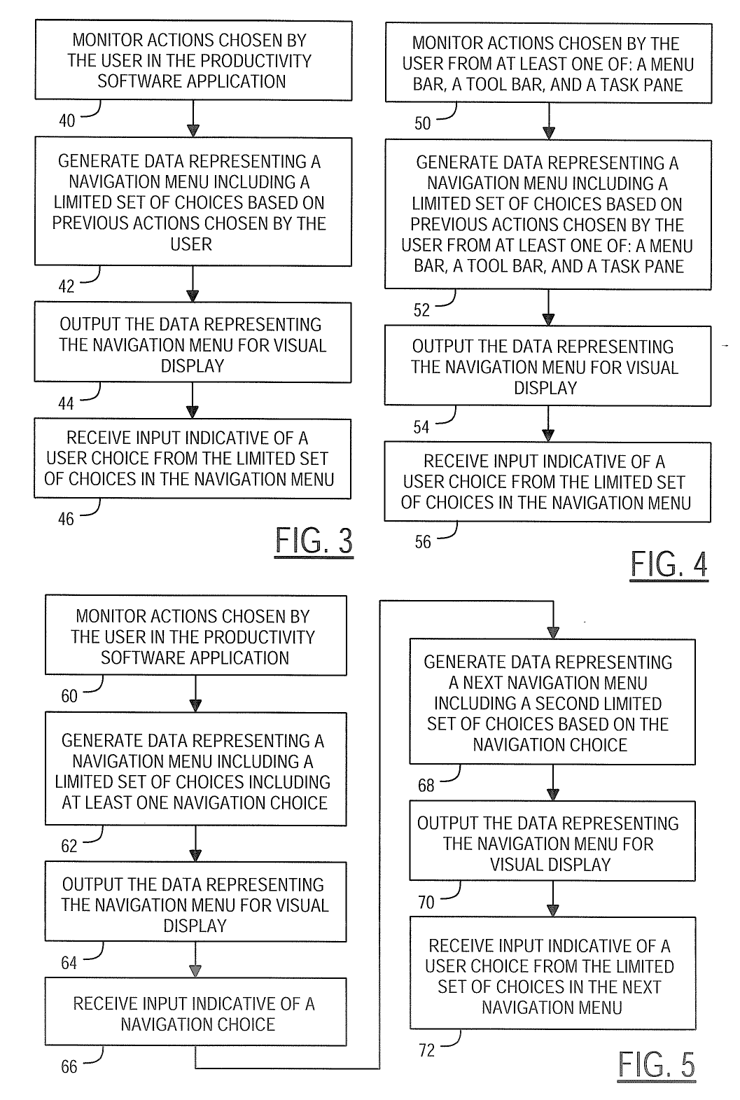

FIG. 3 is a block diagram illustrating a method of the invention. At block 40, the computer monitors actions chosen by the user in the productivity software application. At block 42, data is generated representing a navigation menu including a limited set of choices based on previous actions taken by the user. At block 44, the data representing the navigation menu is output for visual display. At block 46, the computer receives an input indicative of a user choice from the limited set of choices in the navigation menu.

FIG. 4 is a block diagram illustrating another method of the invention. At block 50, the computer monitors actions chosen by the user. Block 50 specifically illustrates the case where the computer monitors actions chosen from a menu bar, a tool bar, and/or a task pane. At block 52, data is generated representing a navigation menu including a limited set of choices based on previous actions chosen by the user from the menu bar, tool bar, and/or task pane. At block 54, data representing the navigation menu is output for visual display. At block 56, the computer receives input indicative of a user choice from the limited set of choices in the navigation menu.

Turning now to FIG. 5, a method of the invention is illustrated in further detail, illustrating the selection of a navigation choice and the navigation to a next navigation menu with additional choices. At block 60, the computer monitors actions chosen by the user in the productivity software application. At block 62, the computer generates data representing a navigation menu including a limited set of choices including at least one navigation choice. At block 64, the data representing the navigation menu is output for visual display. At block 66, the computer receives an input indicative of a navigation choice. In response thereto, at block 68, the computer generates data representing a next navigation menu including a second limited set of choices based on the navigation choice. At block 70, the data representing the next navigation menu is output for visual display. Finally, at block 72, the computer receives input indicative of a user choice from the limited set of choices in the next navigation menu.

FIG. 6 illustrates another method of the invention. According to FIG. 6, prior to the previous actions chosen by the user in the productivity software application being sufficient to determine the limited set of choices for the navigation menu, the navigation menu may include a default limited set of choices. In more detail, block 80 depicts the computer generating data representing a navigation menu including a default limited set of choices. At block 82, the data representing the navigation menu is output for visual display. At block 84, the computer monitors actions chosen by the user in the productivity application.

FIG. 7 illustrates another method of the invention, one in which there is a change mode choice available to switch between a simple navigation menu and a full navigation menu. At block 90, the computer monitors actions chosen by the user in the productivity software application. At block 92, the computer generates data representing a navigation menu including a limited set of choices including a change mode choice. At block 94, the data representing the navigation menu is output for visual display. At block 96, the computer receives input indicative of a change mode choice. At block 98, the computer generates data representing a full navigation menu including the limited set of choices and a plurality of support choices. At block 100, the data representing the full navigation menu is output for visual display. At block 102, the computer receives input indicative of a user choice in the full navigation menu.

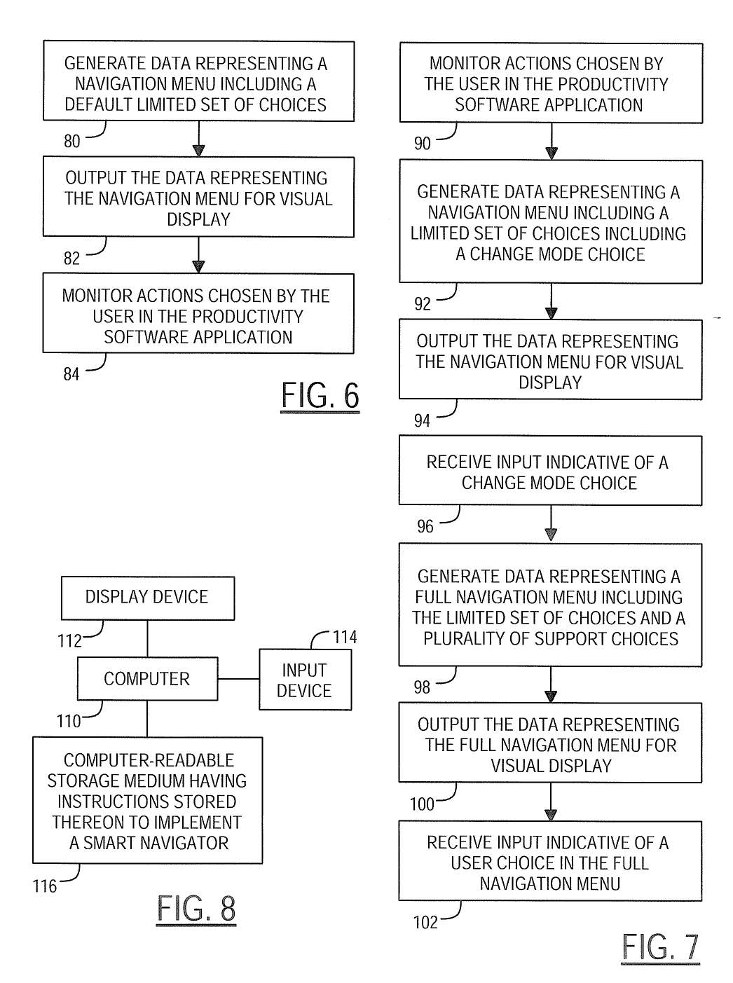

FIG. 8 is a computer system in an embodiment of the invention. The computer system includes computer 110, display device 112, input device 114, and computer-readable storage medium 116. The medium 116 has instructions stored thereon to direct the computer system to implement various methods of the invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer-readable storage medium having instructions stored thereon to direct a computer to:
while running a productivity software application wherein a user chooses actions, monitor actions chosen by the user in the productivity software application;
generate data representing a navigation menu, the navigation menu including a limited set of choices based on previous actions chosen by the user in the productivity software application;
output the data representing the navigation menu for visual display; and
receive input indicative of a user choice from the limited set of choices in the navigation menu.

2. The computer-readable storage medium of claim 1 wherein while running the productivity software application, the user chooses actions from at least one of: a menu bar, a tool bar, and a task pane, the medium further having instructions stored thereon to direct the computer to:
monitor actions chosen by the user from at least one of: a menu bar, a tool bar, and a task pane;
wherein the limited set of choices in the navigation menu is based on previous actions chosen by the user from at least one of: a menu bar, a tool bar, and a task pane.

3. The computer-readable storage medium of claim 1 wherein the navigation menu includes, among the limited set of choices, at least one navigation choice.

4. The computer-readable storage medium of claim 3 further having instructions stored thereon to direct the computer to:
upon receiving input indicative of a user choice being a navigation choice, generate data representing a next navigation menu, the next navigation menu including a second limited set of choices based on the navigation choice, and further based on previous actions chosen by the user in the productivity software application; and
output the data representing the next navigation menu for visual display.

5. The computer-readable storage medium of claim 1 further having instructions stored thereon to direct the computer to:
output the data representing the navigation menu for visual display such that the navigation menu includes a preselected user choice.

6. The computer-readable storage medium of claim 1 wherein the navigation menu includes, among the limited set of choices, an undo/back choice.

7. The computer-readable storage medium of claim 1 further having instructions stored thereon to direct the computer to:
receive input indicative of user navigation among the limited set of choices in the navigation menu.

8. The computer-readable storage medium of claim 1 further having instructions stored thereon to direct the computer to:
prior to the previous actions chosen by the user in the productivity software application being sufficient to determine the limited set of choices for the navigation menu, generate data representing the navigation menu, wherein the navigation menu includes a default limited set of choices.

9. The computer-readable storage medium of claim 1 wherein the productivity software application comprises an office software suite, the medium further having instructions stored thereon to direct the computer to:
while running the office software suite, monitor actions chosen by the user in the office software suite.

10. The computer-readable storage medium of claim 1 further having instructions stored thereon to direct the computer to:
generate data representing a second navigation menu, the second navigation menu including a second limited set of choices based on previous actions chosen by the user in the productivity software application;
output the data representing the second navigation menu for visual display; and
receive input indicative of a user choice from the second limited set of choices in the second navigation menu.

11. The computer-readable storage medium of claim 1 wherein the navigation menu includes, among the limited set of choices, at least one change mode choice.

12. The computer-readable storage medium of claim 11 further having instructions stored thereon to direct the computer to:
upon receiving input indicative of a user choice being the change mode choice, generate data representing a full navigation menu, the full navigation menu including the limited set of choices and further including a plurality of support choices; and
output the data representing the full navigation menu for visual display.

13. The computer-readable storage medium of claim 12 wherein the support choices include a help choice.

14. The computer-readable storage medium of claim 12 wherein the support choices include a next choice, the medium further having instructions stored thereon to direct the computer to:
upon receiving input indicative of a user choice being the next choice, generate data representing a next navigation menu, the next navigation menu including a second limited set of choices based on previous actions chosen by the user in the productivity software application; and
output the data representing the next navigation menu for visual display.

15. The computer-readable storage medium of claim 12 wherein the support choices include a self choice, the medium further having instructions stored thereon to direct the computer to:
upon receiving input indicative of a user choice being the self choice, generate data representing a next navigation menu, the next navigation menu including a second limited set of choices that are custom selected by the user; and
output the data representing the next navigation menu for visual display.

16. The computer-readable storage medium of claim 1 wherein the navigation menu further includes a next choice, the medium further having instructions stored thereon to direct the computer to:
upon receiving input indicative of a user choice being the next choice, generate data representing a next navigation menu, the next navigation menu including a second limited set of choices based on previous actions chosen by the user in the productivity software application; and
output the data representing the next navigation menu for visual display.

17. The computer-readable storage medium of claim 1 wherein the navigation menu further includes a self choice, the medium further having instructions stored thereon to direct the computer to:
upon receiving input indicative of a user choice being the self choice, generate data representing a next navigation menu, the next navigation menu including a second limited set of choices that are custom selected by the user; and
output the data representing the next navigation menu for visual display.

18. A computer-readable storage medium having instructions stored thereon to direct a computer to:
while running a software application wherein a user chooses actions, monitor actions chosen by the user in the software application;
generate data representing a navigation menu, the navigation menu including a limited set of choices based on previous actions chosen by the user in the software application;
output the data representing the navigation menu for visual display; and
receive input indicative of a user choice from the limited set of choices in the navigation menu.

19. A computer-implemented method comprising:
while running a software application wherein a user chooses actions, monitoring actions chosen by the user in the software application;
generating data representing a navigation menu, the navigation menu including a limited set of choices based on previous actions chosen by the user in the software application;
outputting the data representing the navigation menu for visual display; and
receiving input indicative of a user choice from the limited set of choices in the navigation menu.

20. The method of claim 19 wherein the navigation menu includes, among the limited set of choices, at least one navigation choice, the method further comprising:
upon receiving input indicative of a user choice being a navigation choice, generating data representing a next navigation menu, the next navigation menu including a second limited set of choices based on the navigation choice, and further based on previous actions chosen by the user in the software application; and
outputting the data representing the next navigation menu for visual display.
